(19) United States
(12) Patent Application Publication
(10) Pub. No.: US 2021/0221223 A1
(43) Pub. Date: Jul. 22, 2021

(54) VEHICLE

(71) Applicants: TOYOTA JIDOSHA KABUSHIKI KAISHA, Toyota-shi (JP); HINO MOTORS, LTD., Hino-shi (JP)

(72) Inventors: Yutaka SAWADA, Nagakute-shi (JP); Yukihide YOKOYAMA, Toyota-shi (JP)

(73) Assignees: TOYOTA JIDOSHA KABUSHIKI KAISHA, Toyota-shi (JP); HINO MOTORS, LTD., Hino-shi (JP)

(21) Appl. No.: 17/063,881

(22) Filed: Oct. 6, 2020

(30) Foreign Application Priority Data
Nov. 5, 2019 (JP) 2019-200662

(51) Int. Cl. B60K 15/063; B60K 15/03

(52) U.S. Cl. CPC B60K 15/063; B60K 2015/03118; B60K 2015/0638

(57) ABSTRACT

A vehicle includes a plurality of fuel tanks in which fuel is stored, and a fuel consuming unit that is connected to the fuel tanks and that consumes the fuel supplied from the fuel tanks to obtain a driving force of the vehicle. The fuel tanks are arranged such that a longitudinal direction of the fuel tanks extends along a height direction of the vehicle.

### INCORPORATION BY REFERENCE

The disclosure of Japanese Patent Application No. 2019-200662 filed on Nov. 5, 2019 including the specification, drawings and abstract is incorporated herein by reference in its entirety.

### BACKGROUND

### 1. Technical Field

The present disclosure relates to vehicles.

### 2. Description of Related Art

There are vehicles equipped with fuel tanks that store fuel consumed by the vehicles. For example, Japanese Unexamined Patent Application Publication No. 2005-35388 (JP 2005-35388 A) discloses a truck equipped with fuel tanks that store compressed natural gas as a fuel. In the truck of JP 2005-35388 A, the fuel tanks are vertically stacked so that the longitudinal direction thereof coincides with the width direction of the vehicle.

### SUMMARY

In such a vehicle, it is desirable to be able to increase the number of fuel tanks to be mounted, in order to extend the cruising range. However, increasing the number of fuel tanks to be mounted may lead to increase in size of the vehicle in the front-rear direction and the width direction depending on the arrangement of the fuel tanks. Further, when the fuel tanks are stacked in the vertical direction as in JP 2005-35388 A, the number of fuel tanks that can be stably stacked upward may be limited. Thus, it has not been easy to increase the number of fuel tanks to be mounted in the limited space in the vehicle using the method of mounting the fuel tanks according to the related art.

The technology of the present disclosure can be implemented as the following aspect.

An aspect of the disclosure provides a vehicle. The vehicle includes a plurality of fuel tanks in which fuel is stored, and a fuel consuming unit connected to the fuel tanks and configured to consume the fuel supplied from the fuel tanks to obtain a driving force of the vehicle. The fuel tanks are arranged such that a longitudinal direction of the fuel tanks extends along a height direction of the vehicle. With the vehicle of the above aspect, it is possible to increase the number of fuel tanks to be mounted by a method different from that of vertically stacking the fuel tanks, while suppressing increase in size of the vehicle in the front-rear direction and the width direction.

The vehicle of the above aspect may further include a tractor head including a chassis on which the fuel tanks are mounted, a vehicle cabin in which an occupant rides, and a connected portion provided at a position rearward of the vehicle cabin and at a center of the chassis in a width direction of the vehicle, and a trailer that includes, rearward of a front end of the trailer, a connecting portion configured to be connected to the connected portion, and that is connected to the tractor head and towed by the tractor head while being turnable in the width direction of the vehicle about the connecting portion. The fuel tanks may be arranged between the vehicle cabin and a turning region of the trailer. With the vehicle of the above aspect, it is possible to mount a large number of fuel tanks in the limited narrow space between the tractor head and the trailer.

In the vehicle of the above aspect, the fuel tanks may each have a cylindrical body having a central axis extending along the longitudinal direction, the fuel tanks may constitute a plurality of tank rows each having fuel tanks arranged side by side in the width direction of the vehicle, the tank rows may be arranged side by side in a front-rear direction of the vehicle, the tank rows may include a front tank row and a rear tank row that are adjacent to each other in the front-rear direction of the vehicle, and the rear tank row may include a fuel tank that is arranged at a position obliquely rearward of and adjoining to a fuel tank included in the front tank row. With the vehicle of the above aspect, gaps between the fuel tanks can be reduced. Thus, it is possible to further suppress increase in size of the mounting space for the fuel tanks in the front-rear direction and the width direction of the vehicle.

In the vehicle of the above aspect, the rear tank row may include a fuel tank that is arranged at a position obliquely rearward of and adjoining to two of the fuel tanks, which are included in the front tank row and adjacent to each other in the width direction of the vehicle. With the vehicle of the above aspect, the fuel tanks can be arranged in a more compact manner.

In the vehicle of the above aspect, in a rear end tank row located at a rearmost position of the tank rows, the fuel tanks may be arranged at opposite ends in the width direction of the vehicle with a space with no fuel tank interposed between the fuel tanks. With the vehicle of the above aspect, the space between the fuel tanks at the opposite ends of the rear end row facilitates securing a space for the trailer to turn. Further, it is possible to suppress a situation where regions at the opposite ends in the width direction of the vehicle in front of the turning region become dead spaces due to securing of the turning region of the trailer, which enables the limited space in the vehicle to be effectively utilized.

In the vehicle of the above aspect, the fuel tanks may include two or more of the fuel tanks, which are arranged at positions facing the turning region, and when viewed in the height direction of the vehicle, end portions of the fuel tanks arranged at the positions facing the turning region may be located such that an end portion located closer to a center in the width direction of the vehicle is located closer to a front of the vehicle, the end portions being portions closest to the turning region in the respective fuel tanks. With the vehicle of the above aspect, the fuel tanks can be arranged along the outer edge of the turning region of the trailer. Therefore, the distance between the mounting space for the fuel tanks and the turning region of the trailer can be reduced, so that it is possible to suppress increase in size of the vehicle in the front-rear direction.

In the vehicle of the above aspect, the fuel tanks may be arranged such that, when viewed in the width direction of the vehicle, the fuel tanks that are adjacent to each other in the front-rear direction of the vehicle partially overlap each other, and when viewed in the front-rear direction of the vehicle, the fuel tanks that are adjacent to each other in the width direction of the vehicle partially overlap each other. With the vehicle of the above aspect, the fuel tanks can be arranged in a more compact manner. Thus, it is possible to suppress increase in size of the mounting space for the fuel tanks in the front-rear direction and the width direction of the vehicle.

The technology of the present disclosure can be implemented in various forms other than a vehicle. For example, the technology can be realized in the form of a tank mounting method, a tank mounting structure, a fuel tank storage portion and the like for a vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic side view of a vehicle according to a first embodiment;

FIG. 2 is a schematic plan view of the vehicle according to the first embodiment;

FIG. 3 is a schematic plan view of a vehicle according to a second embodiment;

FIG. 4 is a schematic side view of a vehicle according to a third embodiment; and

FIG. 5 is a schematic side view of a vehicle according to a fourth embodiment.

### DETAILED DESCRIPTION OF EMBODIMENTS

### 1. First Embodiment

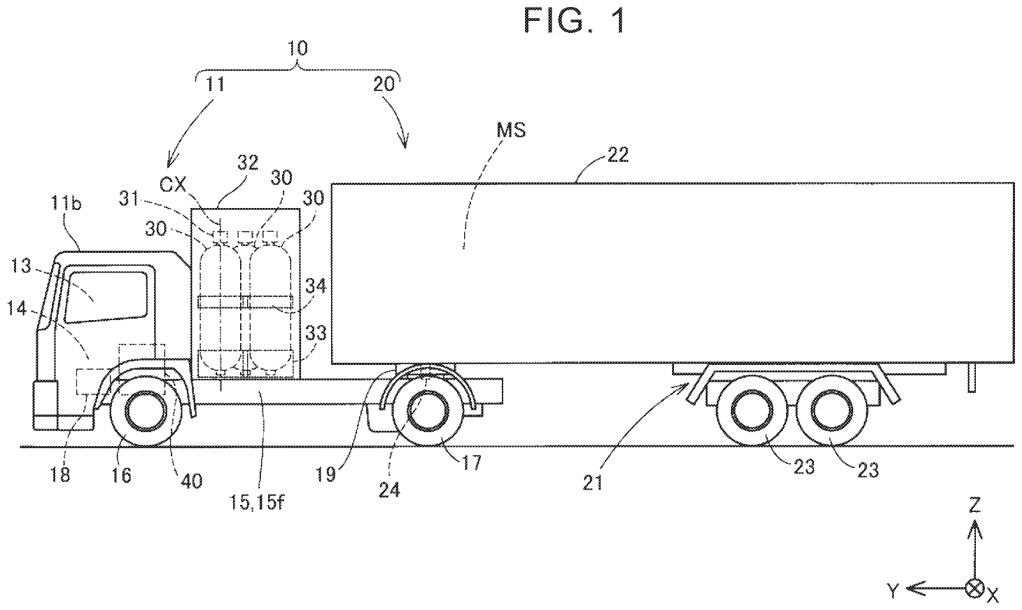

FIG. 1 is a schematic side view showing a vehicle 10 according to a first embodiment. In FIG. 1, arrows indicating an X direction, a Y direction, and a Z direction that are orthogonal to each other are illustrated. The X direction corresponds to a width direction of the vehicle 10, the Y direction corresponds to a front-rear direction of the vehicle 10, and the Z direction corresponds to a height direction of the vehicle 10. The height direction of the vehicle 10 is a direction parallel to the vertical direction when the vehicle 10 is in a posture in which the width direction and the front-rear direction thereof are horizontal. The arrows indicating the X direction, the Y direction, and the Z direction are illustrated in each of the drawings referred to later so as to correspond to FIG. 1.

The vehicle 10 is configured as a freight vehicle. In the present specification, the “freight vehicle” means a vehicle mainly intended to transport freight and having a loading space for freight rearward of a vehicle cabin. The loading space has a larger area than the vehicle cabin when viewed in the height direction. In the present specification, the configuration “having a loading space” includes a configuration to which a cargo room and a cargo bed can be added to form the loading space.

In the present embodiment, the vehicle 10 includes a tractor head 11 that is a towing vehicle having a vehicle cabin 13 in which occupants including a driver ride, and a trailer 20 that is a towed vehicle on which freight is loaded. In the vehicle 10, the trailer 20 is connected to the rear of the tractor head 11 to form a freight loading space MS rearward of the vehicle cabin 13. In the present embodiment, the cargo room in a container 22 described later constitutes the freight loading space MS. Thus, the tractor head 11 is configured such that the cargo room and the cargo bed can be added so as to form the loading space MS rearward of the vehicle cabin 13. Thus, according to the definition of the “freight vehicle” in the specification, the tractor head 11 alone to which the trailer 20 is not connected can also be regarded as the freight vehicle.

The tractor head 11 includes a body portion 11b and a chassis 15. The body portion 11b includes therein the vehicle cabin 13 mentioned above and an engine compartment 14 provided below the vehicle cabin 13. The body portion 11b is supported by a front end of the chassis 15. The chassis 15 includes a pair of vehicle frames 15f arranged along the front-rear direction of the vehicle 10. The vehicle frames 15f are also referred to as side frames and are arranged in parallel and spaced from each other in the width direction. The vehicle frames 15f extend rearward of the body portion 11b from the engine compartment 14 in the body portion 11b along the Y direction.

Front wheels 16 and rear wheels 17 of the tractor head 11 are attached to the outer sides of the chassis 15 in the X direction. The front wheels 16 are located below the vehicle cabin 13, and the rear wheels 17 are located near the rear end of the chassis 15. The front wheels 16 are drive wheels that are connected to a driving force source 18 housed in the engine compartment 14 and are rotated by a driving force transmitted from the driving force source 18. In the present embodiment, the driving force source 18 is composed of a motor driven by electric power output from a fuel cell unit 40 described later. The rear wheels 17 are provided at positions near the rear end of the chassis 15.

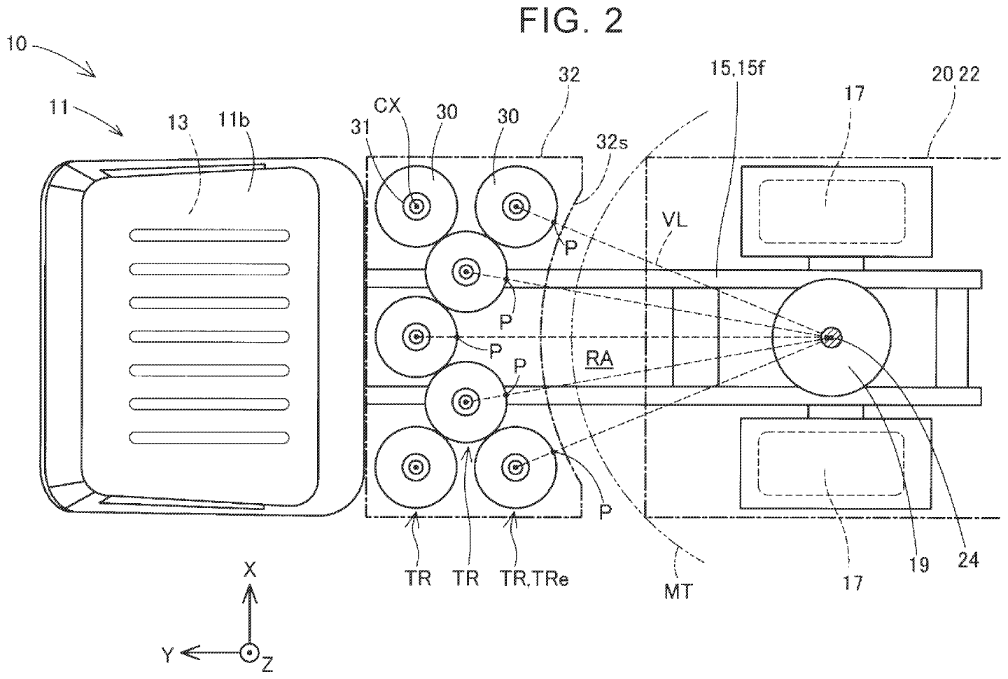

A connected portion 19 is provided near the rear wheels 17. As shown in FIG. 2 to be referred to later, the connected portion 19 is provided at a center of the vehicle 10 in the width direction between the vehicle frames 15f The connected portion 19 is fixed to the chassis 15. A connecting portion 24 of the trailer 20 is connected to the connected portion 19. The connected portion 19 is composed of a so-called coupler.

The trailer 20 has a trailer chassis 21 to which driven wheels 23 are attached, and the container 22 supported on the trailer chassis 21. The container 22 is configured as a rectangular hollow box body. The container 22 constitutes the loading space MS of the vehicle 10 and includes therein a cargo room in which freight is stored. The container 22 is made of, for example, iron or aluminum alloy.

The connecting portion 24 that is connected to the connected portion 19 of the tractor head 11 described above is provided on the bottom surface of the container 22. The connecting portion 24 is composed of a so-called kingpin. The connecting portion 24 projects downward from the bottom surface of the container 22 at a position rearward of the front end of the container 22, and is inserted into and engaged with the center of the connected portion 19 from above. The trailer 20 is towed by the tractor head 11 while being allowed to turn in the width direction about the connecting portion 24 with respect to the tractor head 11. In other embodiments, the container 22 may be omitted. Instead of the container 22, the trailer 20 may be provided with a cargo bed that is provided with the connected portion 19 and a fixture for fixing the freight and that is disposed on the trailer chassis 21.

The vehicle 10 has a plurality of fuel tanks 30 that is mounted on the chassis 15 and stores fuel consumed to obtain the driving force of the vehicle 10. In the vehicle 10, the fuel tanks 30 are mounted between the vehicle cabin 13 and the trailer 20. Each fuel tank 30 has a cylindrical body with a longitudinal direction thereof coinciding with a direction along a central axis CX. Each fuel tank 30 is disposed such that the longitudinal direction thereof extends along the height direction of the vehicle 10. In the present embodiment, each fuel tank 30 has the same dimensions. However, in other embodiments, the dimensions of each fuel tank 30 need not be uniform. The fuel tanks 30 may differ in diameter or length.

In the present embodiment, the vehicle 10 is configured as a fuel cell vehicle, and the fuel tanks 30 store a fuel gas consumed in power generation by the fuel cell described later. In the present embodiment, the fuel tanks 30 store hydrogen serving as the fuel gas. Each fuel tank 30 is configured as a high-pressure tank having a pressure resistance of, for example, 70 MPa or more, and can store a fuel gas compressed to high pressure. Each fuel tank 30 has a structure in which the surface of a liner, which is a resin container, is covered with a fiber-reinforced resin layer serving as a reinforcing layer. The liner may be made of a light metal such as aluminum instead of the resin member. The fiber-reinforced resin layer is formed by a filament winding method. The fiber-reinforced resin layer is composed of reinforcing fibers such as carbon-fiber-reinforced plastic (CFRP) wound around the outer surface of the liner, and a thermosetting resin that binds the reinforcing fibers together.

A cap 31 is provided at an end of each fuel tank 30 in the longitudinal direction. A pipe for circulating the fuel is connected to the cap 31. Illustration and detailed description of the pipe are omitted. The cap 31 is provided with an on-off valve (not shown) for controlling inflow/outflow of the fuel gas to/from the fuel tank 30 and a fusion valve (not shown) that melts when its temperature exceeds a certain temperature to allow the gas to leak to the outside of the fuel tank 30.

In the vehicle 10, the fuel tanks 30 are stored in a storage portion 32. The storage portion 32 is composed of a hollow box body. The storage portion 32 is provided between the body portion 11b and the container 22, that is, between the vehicle cabin 13 and the loading space MS and is fixed on the chassis 15. The storage portion 32 is made of, for example, acrylonitrile butadiene styrene (ABS) resin or fiber-reinforced plastic. In other embodiments, the storage portion 32 may be omitted.

The fuel tanks 30 are supported, in the storage portion 32, by a support member 33 that is provided at the lower end of the storage portion 32 and that receives the lower ends of the fuel tanks 30. The fuel tanks 30 are fixed in the storage portion 32 while being connected to each other with a fastening member 34. The support member 33 and the fastening member 34 enhance the stability of the arrangement posture of each fuel tank 30 in the storage portion 32. In other embodiments, the fuel tanks 30 may be supported in the storage portion 32 by a frame configured by assembling frame members. The arrangement of the fuel tanks 30 in the storage portion 32 will be described later.

The vehicle 10 includes, as an electric power source, the fuel cell unit 40 including a fuel cell. The fuel cell unit 40 is a unit including the fuel cell and devices integrally attached to a fuel cell body. The “devices integrally attached to the fuel cell body” include, for example, a case for accommodating the fuel cell, a frame for supporting the fuel cell, sensors, valves, pumps, pipe connecting members, and the like. The fuel cell unit 40 is mounted in the engine compartment 14. The fuel cell unit 40 is supported by the chassis 15 via a mount. In the vehicle 10 of the present embodiment, the electric power output from the fuel cell unit 40 is mainly supplied to the driving force source 18 and used for traveling of the vehicle 10. The vehicle 10 may include, in addition to the driving force source 18, an internal combustion engine that generates the driving force of the vehicle 10 such that a driving force for assisting the driving force generated by the internal combustion engine is obtained from the driving force source 18. Further, the electric power output from the fuel cell unit 40 may be used not only for traveling of the vehicle 10 but also for electrical components inside the vehicle 10 or for external power supply.

In the present embodiment, the fuel cell included in the fuel cell unit 40 is a polymer electrolyte fuel cell, and is configured as a fuel cell stack in which a plurality of unit cells are stacked. Each unit cell has a membrane electrode assembly in which electrodes are arranged on the opposite sides of an electrolyte membrane, and is an element that can generate electric power by itself. The fuel cell mounted in the vehicle 10 is not limited to the polymer electrolyte fuel cell. In other embodiments, various types of fuel cells, such as a solid oxide fuel cell, can be used as the fuel cell.

A fuel cell generates electric power by an electrochemical reaction between a fuel gas and an oxidant gas. As described above, in the present embodiment, hydrogen stored in each fuel tank 30 is used as the fuel gas. Further, as the oxidant gas, oxygen contained in air taken in by a compressor (not shown) installed in the engine compartment 14 is used. In the vehicle 10 of the present embodiment, the fuel cell of the fuel cell unit 40 functions as a fuel consuming unit that consumes the fuel stored in the fuel tanks 30 to obtain the driving force of the vehicle 10. In other embodiments, at least part of the fuel tanks 30 may store an oxidant gas instead of the fuel gas.

FIG. 2 is a schematic plan view of the vehicle 10 as viewed from above. In FIG. 2, for convenience, outlines of the storage portion 32 and the trailer 20 are shown by long dashed short dashed lines, and the fuel tanks 30 in the storage portion 32 are shown by continuous lines. Further, in FIG. 2, the support member 33 and the fastening member 34 are not shown.

As described above, the container 22 of the trailer 20 can turn in the width direction of the vehicle 10 about the connecting portion 24 with respect to the tractor head 11. In FIG. 2, a movement trajectory MT of tip portions of the container 22 when the container 22 turns is illustrated by a long dashed double-short dashed line. A region on the connecting portion 24 side of the movement trajectory MT corresponds to a turning region RA that indicates a region in which the trailer 20 turns. In the vehicle 10, as described above, each fuel tank 30 is mounted such that the longitudinal direction thereof extends along the height direction of the vehicle 10. Accordingly, it is possible to arrange the fuel tanks 30 in the limited narrow space between the body portion 11b having the vehicle cabin 13 and the turning region RA of the trailer 20. It is also possible to easily increase the number of the fuel tanks 30 to be mounted while suppressing increase in size of the vehicle 10 in the front-rear direction and the width direction.

In the vehicle 10, the fuel tanks 30 are arranged such that the fuel tanks 30 adjacent to each other in the front-rear direction of the vehicle 10 partially overlap each other when viewed in the width direction of the vehicle 10. The fuel tanks 30 are also arranged such that the fuel tanks 30 adjacent to each other in the width direction of the vehicle 10 partially overlap each other when viewed in the front-rear direction of the vehicle 10. Accordingly, the fuel tanks 30 can be arranged in a more compact manner, thereby suppressing increase in size of a mounting space for the fuel tanks 30 in the front-rear direction and the width direction of the vehicle 10.

In the vehicle 10, a plurality of tank rows TR each including the fuel tanks 30 arranged side by side in the width direction of the vehicle 10 is arranged side by side in the front-rear direction of the vehicle 10. The fuel tanks 30 included in a rear tank row TR, of the two tank rows TR that are adjacent to each other in the front-rear direction of the vehicle 10, are each disposed at a position obliquely rearward of and adjoining to the fuel tanks 30 included in a front tank row TR. More specifically, the fuel tanks 30 included in the rear tank row TR are each disposed at a position obliquely rearward of and adjoining to each of the two fuel tanks 30 arranged adjacent to each other in the width direction of the vehicle 10 in the front tank row TR. It should be noted that the “adjoining position” is a concept that includes not only a position that realizes actual contact but also a position that is close enough to contact. With this arrangement, gaps between the fuel tanks 30 are reduced, which further suppresses increase in size of the mounting space for the fuel tanks 30 in the front-rear direction and the width direction of the vehicle 10.

The fuel tanks 30 mounted in the vehicle 10 include two or more fuel tanks 30 arranged at positions facing the turning region RA. Here, the “positions facing the turning region RA” means such a position that no other fuel tank 30 is interposed between the turning region RA and the fuel tanks 30 arranged at positions facing the turning region RA. Thus, a configuration in which a wall of the storage portion 32 is interposed between the turning region RA and the fuel tanks 30 arranged at positions facing the turning region RA corresponds to the “positions facing the turning region RA”. In the vehicle 10, when viewed in the height direction of the vehicle 10, end portions P of the fuel tanks 30 arranged at the positions facing the turning region RA are located such that the end portion P located closer to the center in the width direction of the vehicle 10 is located closer to the front of the vehicle 10. In the fuel tanks 30, the end portions P are portions closest to the turning region RA. Each of the end portions P is located at an intersection of a virtual straight line VL connecting the central axis CX of the fuel tank 30 arranged to face the turning region RA and the connecting portion 24 and the outline of the fuel tank 30.

According to the arrangement of the fuel tanks 30 in which the end portions P are located as described above, the mounting space for the fuel tanks 30 when viewed in the height direction of the vehicle 10 is formed such that the rear end of the mounting space is recessed at the center in the width direction of the vehicle 10 toward the front of the vehicle 10. The rear wall of the storage portion 32 has a curved surface 32s that curves such that a portion of the curved surface 32s that is closer to the center in the width direction of the vehicle 10 is located more toward the front of the vehicle 10, conforming to the shape of the mounting space for the fuel tanks 30. Thus, in the vehicle 10, since the fuel tanks 30 are arranged along the turning region RA of the trailer 20, it is possible to reduce the distance between the mounting space for the fuel tanks 30 and the turning region RA of the trailer 20. Therefore, it is possible to suppress increase in size of the vehicle 10 in the front-rear direction due to the mounting space for the fuel tanks 30.

Further, in the vehicle 10, in a rear end tank row TRe located at a rearmost position of the tank rows TR, two fuel tanks 30 are arranged at the opposite ends in the width direction of the vehicle 10 with a space with no fuel tank 30 interposed therebetween. The space between the fuel tanks 30 at the opposite ends of the rear end tank row TRe facilitates securing a space for the trailer 20 to turn. Thus, it is possible to suppress the turning of the trailer 20 from being hindered due to the fuel tanks 30 mounted between the vehicle cabin 13 and the turning region RA. Further, it is possible to suppress a situation where regions at the opposite ends in the width direction of the vehicle 10 in front of the turning region RA become dead spaces due to securing of the turning region RA of the trailer 20, which enables the limited space in the vehicle 10 to be effectively utilized.

As described above, in the vehicle 10 of the first embodiment, the fuel tanks 30 are mounted such that the longitudinal direction thereof extends along the height direction of the vehicle 10. Thus, it is possible to easily increase the number of the fuel tanks 30 to be mounted in the limited space in the vehicle 10 while suppressing increase in size of the vehicle 10 in the front-rear direction and the width direction.

### 2. Second Embodiment

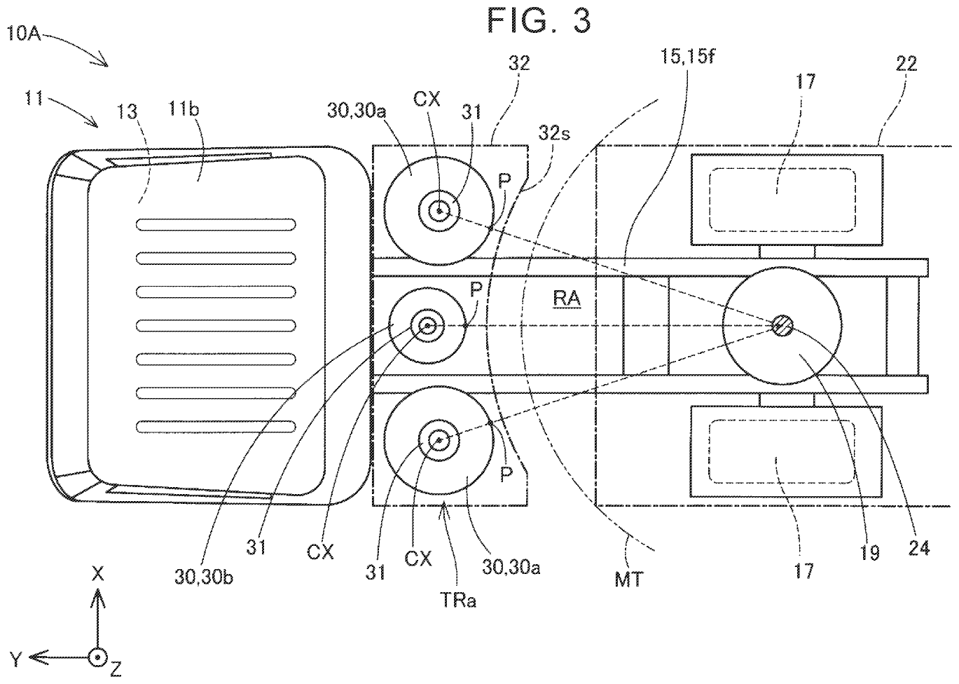

FIG. 3 is a schematic plan view showing a configuration of a vehicle 10A of a second embodiment. The configuration of the vehicle 10A of the second embodiment is substantially the same as that of the vehicle 10 of the first embodiment, except that the way of mounting the fuel tanks 30 is different as described below. In the vehicle 10A of the second embodiment, a single tank row TRa is provided in the storage portion 32. The fuel tanks 30 constituting the tank row TRa include first fuel tanks 30a having a large diameter and a second fuel tank 30b having a small diameter. The first fuel tanks 30a are arranged at opposite ends of the tank row TRa, and the second fuel tank 30b is interposed between the first fuel tanks 30a at the opposite ends. When viewed in the height direction of the vehicle 10A, the end portions P of the fuel tanks 30a, 30b, which are closest to the turning region RA, are located such that the end portion P located closer to the center in the width direction of the vehicle 10A is located closer to the front of the vehicle 10A. Thus, in the vehicle 10A of the second embodiment, the distance between the mounting space for the fuel tanks 30a, 30b and the turning region RA of the trailer 20 can be reduced, as in the vehicle 10 of the first embodiment. In addition, with the vehicle 10A of the second embodiment, various functions and effects similar to those described in the first embodiment can be obtained.

### 3. Third Embodiment

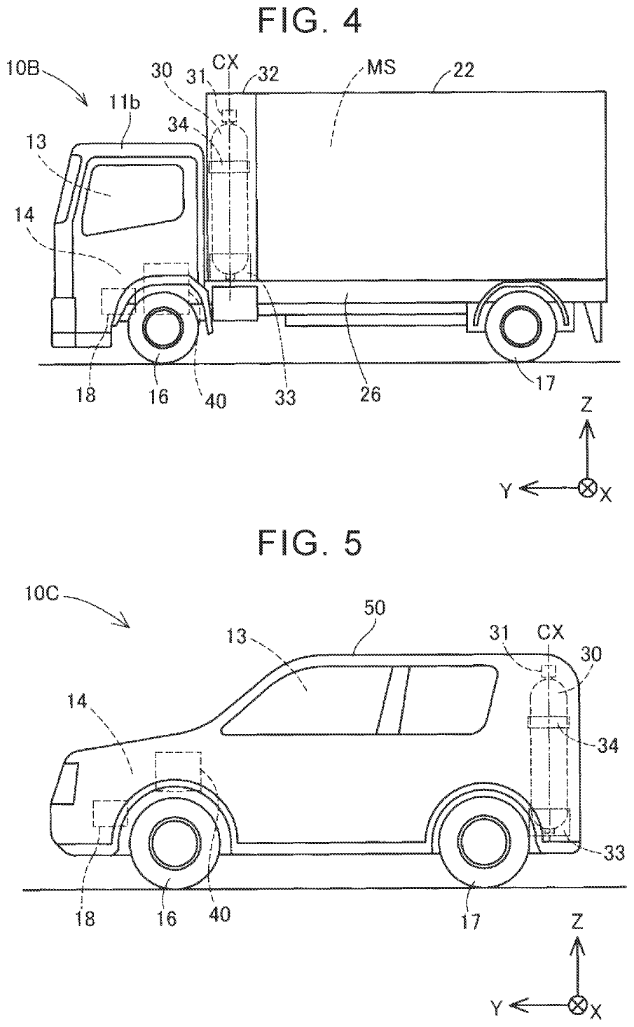

FIG. 4 is a schematic side view showing a vehicle 10B of a third embodiment. Hereinafter, the configuration of the vehicle 10B of the third embodiment is substantially the same as that of the vehicle 10 of the first embodiment unless otherwise specified.

The vehicle 10B of the third embodiment is configured as a freight vehicle in which the body portion 11b having the vehicle cabin 13 and the cargo bed 26 having thereon the loading space MS are integrated. In the example of FIG. 4, the container 22 having therein the loading space MS is mounted on the cargo bed 26.

In the vehicle 10B, the storage portion 32 is provided between vehicle cabin 13 and the loading space MS. In the storage portion 32, the fuel tanks 30 are arranged side by side in the width direction of the vehicle 10B with the longitudinal direction thereof extending along the height direction of the vehicle 10B. In the vehicle 10B of the third embodiment, because of the arrangement posture of the fuel tanks 30, it is easy to increase the number of the fuel tanks 30 to be mounted in the limited space between the vehicle cabin 13 and the loading space MS. In addition, with the vehicle 10B of the third embodiment, various functions and effects similar to those described in the first embodiment can be obtained.

### 4. Fourth Embodiment

FIG. 5 is a schematic side view showing a vehicle 10C of a fourth embodiment. The vehicle 10C of the fourth embodiment is configured as an ordinary passenger car-type fuel cell vehicle that travels by driving the driving force source 18 with the output power of the fuel cell unit 40. In the vehicle 10C, the vehicle cabin 13, the engine compartment 14, and the loading space MS are housed in a main body 50. Further, in the vehicle 10C, the fuel tanks 30 similar to those described in the first embodiment are mounted in the main body 50 such that the longitudinal direction of the fuel tanks 30 extends along the height direction of the vehicle 10C. The fuel tanks 30 are mounted rearward of the vehicle cabin 13. Each fuel tank 30 is fixed to the main body 50 with the support member 33 and the fastening member 34. The fuel tanks 30 are installed at positions toward the opposite ends in the width direction of the vehicle 10C so as not to obstruct a driver's rear view. However, the fuel tanks 30 may be arranged so as to obstruct the driver's rear view. In this case, it is desirable to provide a configuration that the driver can visually recognize the rear with a backup camera or the like. In the vehicle 10C of the fourth embodiment, it is possible to easily increase the number of the fuel tanks 30 to be mounted in the limited space in the main body 50. In addition, with the vehicle 10C of the fourth embodiment, various functions and effects similar to those described in the first embodiment can be obtained.

### 5. Other Embodiments

The various configurations described in the above embodiments can be modified as follows, for example. Each of the other embodiments described below is regarded as an example of modes for carrying out the technology of the present disclosure, like the above-described embodiments.

### Other Embodiment 1

The vehicle 10 need not be configured as a fuel cell vehicle. The vehicle 10 may be configured as a natural gas vehicle, for example. In this case, the natural gas is stored in the fuel tanks 30, and the vehicle 10 is equipped with, as the fuel consuming unit, an engine that is driven by combustion of the natural gas stored in the fuel tanks 30. Further, the vehicle 10 may be configured as a hydrogen vehicle in which hydrogen is stored in the fuel tanks 30 and a hydrogen engine is mounted as the fuel consuming unit. In such configurations, the vehicle 10 need not include the fuel cell unit 40. The fuel stored in the fuel tanks 30 is not limited to gas. The fuel tanks 30 may store liquid fuel such as liquefied natural gas (LNG), liquefied petroleum gas (LPG), gasoline, and light oil.

### Other Embodiment 2

Each fuel tank 30 is not limited to the configuration including the cylindrical body with the longitudinal direction thereof coinciding with the direction along the central axis CX. The fuel tank 30 only needs to have a shape with a longitudinal direction, and may have, for example, a rectangular parallelepiped shape, or a polygonal column shape with a longitudinal direction thereof extending along the height direction.

### Other Embodiment 3

The arrangement of the fuel tanks 30 is not limited to those described in the above embodiments. For example, in the first embodiment, the fuel tanks 30 may be arranged in a grid pattern such that the central axes thereof are arranged side by side in lines in the front-rear direction and the width direction of the vehicle 10. Further, the fuel tanks 30 need not be arranged close to each other, and may be arranged apart from each other. In the first embodiment of the above embodiments, the number of the tank rows TR is not limited to three shown in FIG. 2. The number of the tank rows TR may be two, or may be four or more. When there are four or more tank rows TR, in any two tank rows TR that are adjacent to each other in the front-rear direction of the vehicle 10, the fuel tanks 30 included in the rear tank row TR may be arranged at the positions obliquely rearward of and adjoining to the fuel tanks 30 included in the front tank row TR. Further, the rear tank row TR may include only one fuel tank 30 that is arranged at a position obliquely rearward of and adjoining to the fuel tanks 30 included in the front tank row TR. In the above second embodiment, fuel tanks having different diameters may be further added to the tank row TRa. Further, a plurality of the tank rows TRa may be provided. The arrangement of the fuel tanks 30 described in the first embodiment, the second embodiment, and the other embodiments may be applied to the third embodiment and the fourth embodiment.

### 6. Others

The technology of the present disclosure is not limited to the above-described embodiments, and can be implemented with various configurations without departing from the scope of the disclosure. For example, the technical features in the embodiments corresponding to the technical features in the aspect described in the SUMMARY may be appropriately replaced or combined in order to solve part of or all of the above-mentioned issues or in order to achieve part of or all of the above-mentioned effects. Further, not only the technical features that are described as non-essential in the specification but also other technical features may be appropriately omitted unless described as essential in the specification.

What is claimed is:

1. A vehicle comprising:
a plurality of fuel tanks in which fuel is stored; and
a fuel consuming unit connected to the fuel tanks and configured to consume the fuel supplied from the fuel tanks to obtain a driving force of the vehicle,
wherein the fuel tanks are arranged such that a longitudinal direction of the fuel tanks extends along a height direction of the vehicle.

2. The vehicle according to claim 1, further comprising:
a tractor head including a chassis on which the fuel tanks are mounted, a vehicle cabin in which an occupant rides, and a connected portion provided at a position rearward of the vehicle cabin and at a center of the chassis in a width direction of the vehicle; and
a trailer that includes, rearward of a front end of the trailer, a connecting portion configured to be connected to the connected portion, and that is connected to the tractor head and towed by the tractor head while being turnable in the width direction of the vehicle about the connecting portion,
wherein the fuel tanks are arranged between the vehicle cabin and a turning region of the trailer.

3. The vehicle according to claim 2, wherein:
the fuel tanks each have a cylindrical body having a central axis extending along the longitudinal direction;
the fuel tanks constitute a plurality of tank rows each having fuel tanks arranged side by side in the width direction of the vehicle;
the tank rows are arranged side by side in a front-rear direction of the vehicle;
the tank rows include a front tank row and a rear tank row that are adjacent to each other in the front-rear direction of the vehicle; and
the rear tank row includes a fuel tank that is arranged at a position obliquely rearward of and adjoining to a fuel tank included in the front tank row.

4. The vehicle according to claim 3, wherein
the rear tank row includes a fuel tank that is arranged at a position obliquely rearward of and adjoining to two of the fuel tanks, which are included in the front tank row and adjacent to each other in the width direction of the vehicle.

5. The vehicle according to claim 3, wherein in a rear end tank row located at a rearmost position of the tank rows, the fuel tanks are arranged at opposite ends in the width direction of the vehicle with a space with no fuel tank interposed between the fuel tanks.

6. The vehicle according to claim 2, wherein:
the fuel tanks include two or more of the fuel tanks, which are arranged at positions facing the turning region; and
when viewed in the height direction of the vehicle, end portions of the fuel tanks arranged at the positions facing the turning region are located such that an end portion located closer to a center in the width direction of the vehicle is located closer to a front of the vehicle, the end portions being portions closest to the turning region in the respective fuel tanks.

7. The vehicle according to claim 1, wherein the fuel tanks are arranged such that, when viewed in the width direction of the vehicle, the fuel tanks that are adjacent to each other in the front-rear direction of the vehicle partially overlap each other, and when viewed in the front-rear direction of the vehicle, the fuel tanks that are adjacent to each other in the width direction of the vehicle partially overlap each other.
